(19) United States
(12) Patent Application Publication
(10) Pub. No.: US 2018/0131749 A1
(43) Pub. Date: May 10, 2018

(54) System and Method for Optimizing Data Transfer using Selective Compression

(71) Applicant: Ingram Micro Inc., Irvine, CA (US)

(72) Inventors: Andrey Dobrenko, Novosibirsk (RU); Dmitriy Potapov, Novosibirsk (RU); Sergey Lomakin, Novosibirsk (RU)

(21) Appl. No.: 15/347,848

(22) Filed: Nov. 10, 2016

(51) Int. Cl. H04L 29/08; H04L 12/26; H04L 29/06

(52) U.S. Cl. CPC H04L 67/06; H04L 69/04; H04L 43/08

(57) ABSTRACT

A system and method for optimizing transfer of data using selective compression, the system comprising an analyzer at a source system, the method comprising the steps of the calculating a cost ratio for a transfer of a volume of data, the cost ratio comprising a time to transfer the volume of data with compression, divided by a time to transfer the volume of data without compression, and compressing at the source system, the volume of data, if the cost ratio is less than 1.

### TECHNICAL FIELD

This invention relates to a system and method for transferring large volumes of data, and more particularly, to system and method for optimizing data transfer using selective compression.

### BACKGROUND

Data migration is the transfer of large volumes of data between computer systems. Data migration can occur for a variety of reasons, including storage changes, equipment maintenance, upgrades, application migration, website management, data transfer. For example, a source system comprising a large volume of data might reach its end of life, thereby requiring the transfer of the data to a replacement destination system.

In common situations, the source system (from which a large volume of data currently resides), is remote from the destination system (to which the volume of data will be transferred to). In such situations, the transfer of the volume of data can occur ‘online.’ That is, the source system and destination system are connected via a computer network (e.g. the Internet, or a Local Area Network (LAN)), and any data transfer is performed by routing the data over the computer network. When transferring the volume of data over a computer network, the time it takes to transfer the data (i.e. the transfer times) can be extensive. For example, congestion on the computer network (i.e. large throughputs of network traffic) can result in slow data transfer times.

In order to alleviate the lengthy transfer times, the volume of data can first be compressed before transfer. Compression is the processing of reducing the size of data by eliminating redundant data within the file. For example, a 500 KB file of text might be compressed to 150 KB by removing extra spaces or replacing long character strings with short representations. Other types of files can be compressed (e.g., picture and sound files) if such files have redundant information. Therefore, compression creates a compressed volume of data that can be significantly smaller than the uncompressed version of the same data. When transferring the compressed volume of data, the transfer times are reduced because there is a smaller quantity of data that requires to be transferred.

However, schemes of data transfer using compression face a trade-off among various factors, including the degree of compression, and the computational resources required to compress and decompress the data. For example, the source system which houses the volume of data may have to perform computational steps in order to compress the volume of data, to create the smaller compressed volume of data. These computational steps require the use of computational resources on the source machine, such as, use of central processing unit (CPU) cycles, memory, and storage device (e.g. hard disk) input/output (I/O). Furthermore, compression of large volumes of data can take extended periods of time. In such situations, the time taken to transfer the compressed volume of data to the destination system, may inevitably include the time taken to compress the volume of data at the source system before the transfer.

This trade-off, wherein compression reduces the amount of data to be transferred, but nonetheless requires time to perform the compression, presents a problem. Source systems can experience computational resource exhaustion (e.g. insufficient memory), thereby significantly increasing the time it takes to compress the volume of data. In such situations, the increased time taken to compress the data may make the use of compression prohibitive. That is, the time taken to compress and then transfer data, is longer than if the uncompressed volume of data was transferred without compression. Essentially, the transfer of the volume of data could have been more expeditious without the use of compression. Furthermore, when transferring compressed data to the destination system, the destination system must also use computational resources to decompress the compressed data to obtain the original uncompressed data. This further adds to the overall time taken to transfer the volume of data.

Determining when to apply compression and, when to transfer without the use of compression is problematic. Therefore, there is a need for a system and method for optimizing data transfer using selective compression.

### SUMMARY

The present disclosure discloses a system and method for optimizing data transfer using selective compression. In at least one embodiment of the present disclosure, a system for optimizing data transfer includes a source system, an analyzer configured to collect a plurality of metrics from the source system and the network, the analyzer further configured to calculate a cost ratio for a transfer of a volume of data, via the network to the destination system, the cost ratio comprising a time to transfer the volume of data with compression, divided by a time to transfer the volume of data without compression. In at least one embodiment of the present disclosure, a method for optimizing data transfer using selective compression includes: collecting a plurality of metrics from the source system and the network, receiving a volume of data for transfer to the destination system, calculating a first transfer cost to transfer the volume of data via the network to the destination system with first compressing the volume of data, calculating a second transfer cost to transfer the volume of data via the network to the destination system without compressing the volume of data, constantly determining at the source system, a cost ratio, and compressing the volume of data if the cost ratio is less than 1.

### BRIEF DESCRIPTION OF THE DRAWINGS

The embodiments and other features, advantages and disclosures contained herein, and the manner of attaining them, will become apparent and the present disclosure will be better understood by reference to the following description of various exemplary embodiments of the present disclosure taken in conjunction with the accompanying drawings, wherein:

FIG. 1 displays a schematic drawing of a system for optimizing data transfer using selective compression.

FIG. 2 displays a schematic drawing of a method for optimizing data transfer using selective compression.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in any programming language—interpreted, compiled, or otherwise. These languages may include, but are not limited to, Xcode, iOS, cocoa, cocoa touch, MacRuby, PHP, ASP.net, HTML, HTML5, Ruby, Perl, Java, Python, C++, C#, JavaScript, and/or the Go programming language. It should be appreciated, of course, that one of skill in the art will appreciate that other languages may be used instead, or in combination with the foregoing and that web and/or mobile application frameworks may also be used, such as, for example, Ruby on Rails, System.js, Zend, Symfony, Revel, Django, Struts, Spring, Play, Jo, Twitter Bootstrap and others. It should further be appreciated that the systems and methods disclosed herein may be embodied in software-as-a-service available over a computer network, such as, for example, the Internet. Further, the present disclosure may enable web services, application programming interfaces and/or service-oriented architecture through one or more application programming interfaces or otherwise.

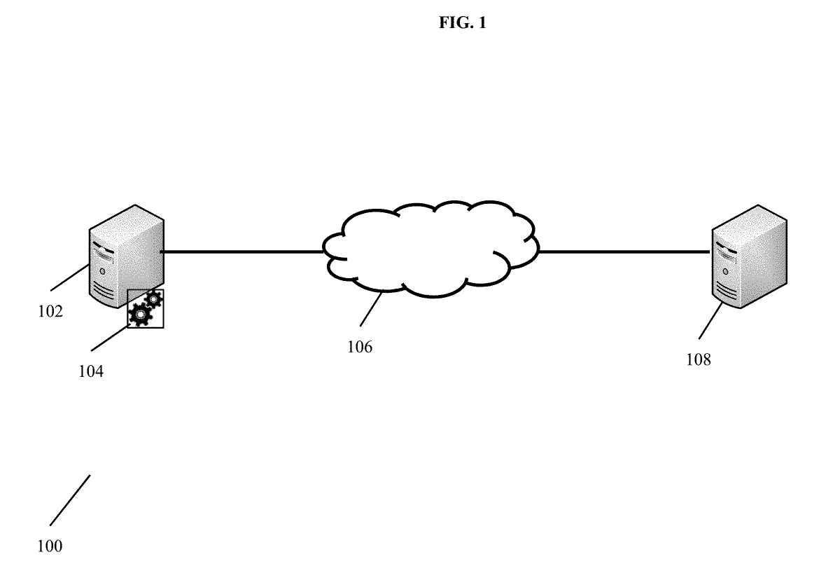

FIG. 1 is a schematic drawing of a system for optimizing data transfer using selective compression, generally indicated at 100. The system includes a source system 102, an analyzer 104, a network 106, and a destination system 108. For purposes of clarity, only one of each component type is shown in FIG. 1. However, it is within the scope of the present disclosure, and it will be appreciated by those of ordinary skill in the art, that the system 100 may have two or more of any of the components shown in the system 100, including the source system 102, the analyzer 104, the network 106, and the destination system 108.

In at least one embodiment of the present disclosure, the source system 102 and destination system 108 may include one or more server computers, computing devices, or systems of a type known in the art. The source system 102 and destination system 108 further include such software, hardware, and componentry as would occur to one of skill in the art, such as, for example, microprocessors, memory systems, input/output devices, host bus adapters, fibre channel, small computer system interface connectors, high performance parallel interface busses, storage devices (e.g. hard drive, solid state drive, flash memory drives), device controllers, display systems, and the like. The source system 102 and destination system 108 may include one of many well-known servers, such as, for example, IBM®'s AS/400® Server, IBM®'s AIX UNIX® Server, or MICROSOFT®'s WINDOWS NT® Server.

In FIG. 1, each of the source system 102 and destination system 108 is shown and referred to herein as a single server. However, each of the source system 102 and destination system 108 may comprise a plurality of servers or other computing devices or systems interconnected by hardware and software systems known in the art which collectively are operable to perform the functions allocated to each of the source system 102 and destination system 108 in accordance with the present disclosure. Each of the source system 102 and destination system 108 may also include a plurality of servers or other computing devices or systems at a plurality of geographically distinct locations interconnected by hardware and software systems (e.g. network 106) known in the art which collectively are operable to perform the functions allocated to the source system 102 and destination system 108 in accordance with the present disclosure.

In at least one embodiment of the present disclosure, the network 106 may include one of the different types of networks, such as, for example, Internet, intranet, local area network (LAN), wide area network (WAN), a metropolitan area network (MAN), a telephone network (such as the Public Switched Telephone Network), the internet, an optical fiber (or fiber optic)-based network, a cable television network, a satellite television network, or a combination of networks, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. It will be further appreciated that the network 106 may include one or more data processing and/or data transfer devices, including routers, bridges, servers, computing devices, storage devices, a modem, a switch, a firewall, a network interface card (NIC), a hub, a bridge, a proxy server, an optical add-drop multiplexer (OADM), or some other type of device that processes and/or transfers data, as would be well known to one having ordinary skills in the art. It should be appreciated that in various other embodiments, various other configurations are possible. Other computer networks, such as Ethernet networks, cable-based networks, and satellite communications networks, well known to one having ordinary skills in the art, and/or any combination of networks are contemplated to be within the scope of the disclosure.

In at least one embodiment of the present disclosure, the source system 102 further includes an analyzer 104. The analyzer 104 further includes such software, hardware, and componentry as would occur to one of skill in the art, such as, for example, microprocessors, memory systems, input/output devices, device controllers, display systems, and the like, which collectively are operable to perform the functions allocated to the analyzer 104 in accordance with the present disclosure. For purposes of clarity, the analyzer 104 is shown as a component of the source system 102. However, it is within the scope of the present disclosure, and it will be appreciated by those of ordinary skill in the art, that the analyzer 104 may be disparate and remote from the source system 102. It will be further appreciated that the remote server or computing device upon which analyzer 104 resides, is electronically connected to the source system 102, the network 106, and destination system 108 such that the analyzer 104 is capable of continuous bi-directional data transfer with each of the components of the system 100.

In at least one embodiment of the present disclosure, the analyzer 104 is configured to collect metrics from the source system 102, the network 106, and the destination system 108. The analyzer 104 is configured to monitor and collect information about the computational components of the system installed thereon. For example, a computational component, as the term is used in the present application, can be a system's CPU, memory, disk, network, application components, and other software components, installed thereon, to name a few non-limiting examples. It will be appreciated that metrics associated with such computational components are of a type and form of server metrics related to system memory, CPU usage, and disk storage. For example, on source system 102 and destination system 108, metrics related to CPU include, CPU usage, CPU speed, CPU load, CPU run queue, idle time, processor time, and privileged time, to name a few non-limiting examples. In yet further embodiments, metrics related to memory on source system 102 and destination system 108, include total memory, free memory, used memory, paging, page faults, swapping, page reads, and page writes, to name a few non-limiting examples. In yet further embodiments, metrics related to disk storage on source system 102 and destination system 108 include, total disk space, disk latency, disk read speed, disk write speeds, disk read time, disk write time, disk queue length, and disk I/Os, to name a few non-limiting examples. It will be appreciated by those of ordinary skill in the art, that such metrics are contemplated for each computational resource component within the source system 102 and destination system 108 (where the source system 102 and destination system 108 comprises a plurality of such components).

In yet further embodiments of the present disclosure, metrics related to network 106 include, measuring link utilization (for example, using Simple Network Management Protocol), number of hops (hop count), speed of the network path, packet loss (router congestion/conditions), latency (delay), path reliability, path bandwidth, throughput, load, maximum transmission unit (MTU), and ping response, to name a few non-limiting examples.

In at least one embodiment of the present disclosure, the analyzer 104 may install monitoring agents of a type well to know one having ordinary skill in the arts, such as, perfmon, IBM Tivoli®, CA® Unified Infrastructure Management, Zabbix®, Nagios Core, Cacti, Wireshark, Ntop, Nmap, BMC® Performance Manager and Patrol, to name a few non-limiting examples. It will be appreciated that the analyzer 104 may install the monitoring agents on the source system 102, the network 106, and the destination system 108.

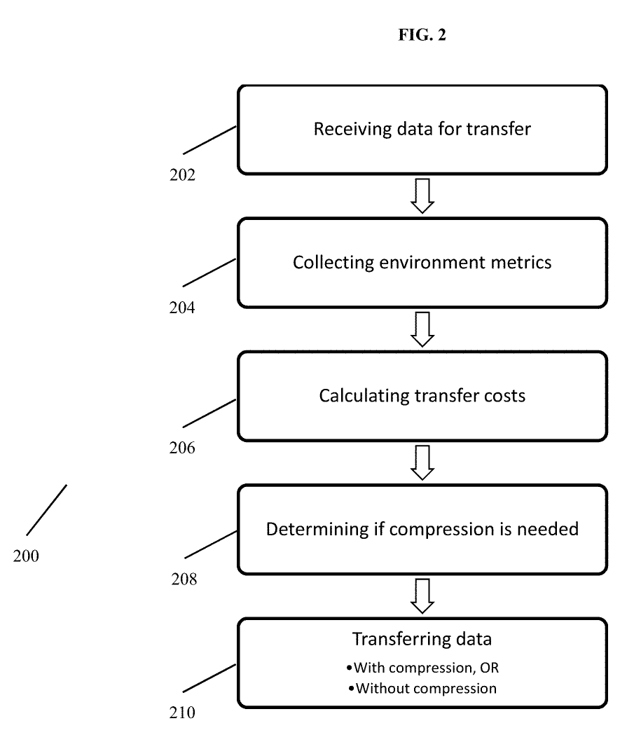

Referring now to FIG. 2, there is shown a schematic flow drawing of a method for optimizing data transfer using selective compression, generally indicated at 200. The method 200 includes step 202 of receiving data for transfer, step 204 of collecting environment metrics, step 206 of calculating transfer costs, step 208 of determining if compression is needed, and step 210 of transferring data with or without compression.

In at least one embodiment of the present disclosure, the source system 102 is configured to receive a large volume of data for transfer at step 202. It will be appreciated that the volume of data may be stored on a storage device on source system 102. In at least one embodiment of the present disclosure, the volume of data includes binary and text files. It will be appreciated that the volume of data includes any types well known to one having ordinary skills in the art, such as, binary data, large binary objects (BLOBs), very large binary objects, audio files, graphics, images, text, or video, to name a few non-limiting examples.

In step 204, the analyzer 104 collects metrics from the source system 102, the network 106, and the destination system 108. In at least one embodiment of the present disclosure, the analyzer 104 collects CPU, memory, and disk, metrics from the source system 102, and destination system 108. In yet further embodiments of the present disclosure, the analyzer 104 collects network metrics from the network 106.

In step 206, the analyzer 104 calculates transfer costs. In at least one embodiment of the present disclosure, the analyzer 104 calculates the costs to transfer the volume of data from source system 102, to destination system 108, via the network 106. In at least one embodiment of the present disclosure, the cost to transfer the volume of data is determined based on the time to transfer. It will be appreciated that the time to transfer, as used in this disclosure, refers to the total time it would take to transfer the volume of data from the source system 102, to the destination system 108. It will be further appreciated that the cost to transfer the volume of data can also be based on other computational resources such as CPU (e.g. how much CPU time is required to transfer the data); bandwidth (e.g. the cost per megabyte of data transferred over the network 106); or, storage cost (e.g. the cost to store the volume of data), to name a few non-limiting examples.

In at least one embodiment of the present disclosure, the time to transfer the volume of data (i.e. τ₁) is expressed by the formula:

τ₁≈m_{original}/Vₙₑₜ+τ_{read}

Wherein, m_{original} is the size of large volume of data without compression, Vₙₑₜ is the bandwidth speed of the network 106 (e.g. in megabits/second (Mb/sec)), and τ_{read} is the time it may take to read the volume of data from the storage device on source system 102. τ_{read}, which is the time it may take to read the volume, is further expressed as:

τ_{read}≈k₅*m_{filecount}*m_{average}

wherein, k₅ is an empirical constant; m_{filecount} is the number of files that need to be transferred; and m_{average} is the average file size of the files that need to be transferred. τ_{read} can further be alternatively expressed as:

$${τ}_{read} \approx \frac{{m}_{original}}{{V}_{hdd}}$$

wherein, V_{hdd} is the read speed of the storage device on source system 102.

In at least on embodiment of the present disclosure, k₅ is an empirical constant that is indicative of a period of time required to read a file of a volume of files. The empirical constant k₅ further comprehends the various factors that affect the time it may take to read the volume of data from the storage device on source system 102. As one example, a storage device that includes a conventional hard disk drive (e.g. a Seagate ST500DM002) has an optimal read (i.e. V_{hdd}) speed. The conventional hard disk drive may include a computer bus interface (e.g. Serial AT Attachment or SATA) for the transfer of data. A SATA interface (e.g. SATA version 3.0) includes ideal I/O speeds of 6 gigabits per second (6 Gbits/s). However, in practical applications, the conventional hard disk drive may not consistently experience I/O speeds of 6 Gbits/s, because of unpredictable factors such as, for example, disk latency, and disk caching, which diminish the expected ideal performance of the storage device. Additional factors that affect a storage device's read speed include the number of files to be read, the fragmentation of the storage device and the files thereon, and the cache size of the storage device, to name a few non-limiting examples. In order to account for such deviation, the empirical constant k₅ represents the factors likely to influence the read speed of the storage device. In at least on embodiment of the present disclosure, a linear dependence was discovered between the number of files to be read, the size of the files to be read, and the time taken to read the files. Therefore, in at least one embodiment of the present disclosure, k₅ has been determined to be approximately 0.00998496317436691, based on testing, wherein the average file size (i.e. m_{average})ᵢₛ 64 KB, and an average HDD reading speed (i.e. V_{hdd}) is approximately 6 MB/s. It will be appreciated that k₅ is an empirical constant obtained from a storage device having certain size, and speed, and that changing the storage device may change the empirical constant. It will be further appreciated that k₅ can be be determined by the empirical data for a different storage device (i.e. different storage devices can have different k₅ values).

In at least one embodiment of the present disclosure, the total time required to transfer the volume of data (τ₂), after being compressed, can be expressed by the formula:

$${τ}_{2} \approx \frac{{m}_{compressed}}{{V}_{net}} + {τ}_{read} + {τ}_{compression} + {τ}_{decompression}$$

wherein, m_{compressed} is the size of a large volume of data after compression, τ_{compression} is the time required for compressing the uncompressed large volume of data at the source system 102, and τ_{decompression} is the time required for uncompressing the compressed large volume of data at the destination system 108.

In at least one embodiment of the present disclosure, when a large volume of data is transferred, the destination system 108 may be superior to the source system 102, in view of the computational resources. That is to say, the computational resources on the destination system 108 may be far more powerful than the computational resources on the source system 102. In such embodiments, τ_{decompression}, the time required for uncompressing the compressed large volume of data at the destination system 108, can be neglected.

In at least one embodiment of the present disclosure, m_{compressed}, the size of a large volume of data after compression, is determined by the formula:

m_{compressed}=k_{bin}m_{bin}+kₜₓₜmₜₓₜ

wherein mₜₓₜ is the size of text portion of the volume of data, k_{bin} is the estimated binary compression ratio, and kₜₓₜ is the estimated text compression ratio. It will be appreciated that the binary compression ratio (k_{bin}) and text compression ratio (kₜₓₜ) are static constants which were empirically determined using test data. In at least one embodiment of the present disclosure, the binary compression ratio (k_{bin}) and text compression ratio (kₜₓₜ) are empirical constants based on data obtained from assessing the compression of various files. It will be appreciated that the binary compression ratio (k_{bin}) and text compression ratio (kₜₓₜ) are static constants that comprehend the variations in the resulting file sizes, after compression. For example, the effectiveness of compression may depend on how much data redundancy is in the file. Files with more data redundancy may have higher compression rates (i.e. the compressed file may be significantly smaller than the pre-compressed original file), while files with less data redundancy may have lower compression rates (i.e. the compressed file may not be significantly smaller than the pre-compressed original file). It will further appreciated that an appropriate compression scheme must also be used. Compressions schemes can vary depending on the type of data in the original file. Some compression schemes are more adept at handling compression of binary files, while other compression schemes are more adept at handling text file. It will be appreciated that any compression scheme may be used, as would be well known to one having ordinary skill in the arts.

In at least one embodiment of the present disclosure, text and binary file types were grouped by extension for testing. Text file type extensions include such as, for example, txt, rtf, php, css, xml, and html. Binary file type extensions include such as, for example, zip, rar, avi, mp4, mpeg, jpg, gif, docs, pptx, mdb, mp3, way, and exe. For each group of file types, an average percent of compression was obtained. The average percent of compression is the percentage change in the file size before and after compression. For example, the following table includes a listing of binary compression ratio (k_{bin}) and text compression ratio (kₜₓₜ) for sample binary and text data files:

| | File Types and Size | Percentage |
|---|---|---|
| Text | plain English text (.txt) 145780 −> 57095 | 39.2 |
| (kₜₓₜ) | plain English text (.txt) 149315 −> 57340 [bytes] | 38.4 |
| | plain English text (.txt) 285499 −> 108571 [bytes] | 38 |
| | plain Russian text (.txt) 1273582 −> 329005 [bytes] | 25.8 |
| | plain Chinesse text (.rtf) 103957 −> 20952 [bytes] | 20.2 |
| | (.php) 55765 −> 12191 [bytes] | 21.9 |
| | (.css) 108382 −> 17026 [bytes] | 15.7 |
| | (.js) 243232 −> 63433 [bytes] | 26.1 |
| | (.csv) 166819 −> 35229 [bytes] | 21.1 |
| | (.xml) 153717 −> 11816 [bytes] | 7.7 |
| | (.html) 217285 −> 32476 [bytes] | 14.9 |
| Binary | Archive (.zip) 51199 −> 47739 [bytes] | 93.2 |
| (k_{bin}) | Archive (.rar) 47761 −> 47158 [bytes] | 98.7 |
| | Video (.avi) 54597676 −> 53711983 [bytes] | 98.4 |
| | Video (.mp4) 22456268 −> 22365031 [bytes] | 99.6 |
| | Video (.mpeg) 596073 −> 553680 [bytes] | 92.9 |
| | Image (.gif) 340483 −> 296795 [bytes] | 87.2 |
| | Image (.jpg) 306289 −> 306340 [bytes] | 100 |
| | Image (.png) 399038 −> 398516 [bytes] | 99.9 |
| | Image (.TIF) 873016 −> 862278 [bytes] | 98.8 |
| | Document (.xlsx) 164868 −> 157906 [bytes] | 95.8 |
| | Document (.docx) 79121 −> 72515 [bytes] | 91.7 |
| | Document (.pptx) 875211 −> 815598 [bytes] | 93.2 |
| | Font (.ttf) 45404 −> 23164 [bytes] | 51 |
| | Audio (.mp3) 22997074 −> 22088965 [bytes] | 96.1 |
| | Audio (.ogg) 105243 −> 103489 [bytes] | 98.3 |
| | Application Flash (.swf) 116887 −> 116929 [bytes] | 100 |
| | Application (.pdf) 433994 −> 411672 [bytes] | 94.9 |
| | Application (.exe) 2871808 −> 1313516 [bytes] | 45.7 |

In at least one embodiment of the present disclosure, the time (τ_{compression}) taken to compress the uncompressed large volume data at the source system 102 is determined using the formula:

τ_{compression}≈m_{original}(k₃+k₄/(1−V_{cpu}))

wherein, V_{cpu} is the CPU load on the source system 102, and k₃, k₄ are static constants that comprehend the variations in processing speed of the CPU(s) on source system 102, and are empirically determined once and are used for all groups of files. It will be appreciated that a compression scheme requires processing power on the source system 102. The time taken to compress an uncompressed large volume of data on source system 102 is dependent on whether the source system 102 has the requisite CPU cycles that can handle the processing requirements of compression. When a source system 102 is at processing capacity (i.e. all the processors are currently busy), the source system 102 may take longer to compress the uncompressed large volume of data. It will therefore be appreciated that variations in processing speed of the CPU(s) on source system 102 may arise from load factors (i.e. if the source system 102 is under a CPU intensive workload, compression time, τ_{compression}, may be consequently increased). For example, in one embodiment of the present disclosure, k₃ and k₄ were obtained for an AMD® FX(tm)-6300 Six-Core CPU unit (3.50 GHz). The CPU was subject to varying processing load, as determined by percent (%) CPU Utilization. The CPU load varied from 10%, to 99% CPU utilization. Continuing with this example, testing demonstrated that here k₃ is approximately equal to 0.05075646656905807711078574914592, and k₄ is approximately equal to 0.41483650561249389946315275744265. It will be appreciated that k₃, and k₄ may be obtained from a CPU having certain number of CPU cores, and speed, and that changing the CPU unit may change the empirical constant. It will be further appreciated that k₃, and k₄ can be determined by the empirical data for different CPU types (i.e. different CPUs can have different k₃, and k₄ values). For example, the calculation of the empirical constants may be influenced based on the CPU characteristics of the source system 102. The CPU characteristics include, core types, number of cores, clock speed, number of caches, cache size, CPU architecture, socket type, and instruction set size and type, to name a few, non-limiting examples.

In at least one embodiment of the present disclosure, the source system 102 may operate to prioritize compression workload such that any compression workload may be provided with a higher priority, over other non-compression workloads. It will be appreciated that compression workload priority can serve to reduce the total time taken to compress the large volume of data. It will be further appreciated that the source system 102 may selectively compress the large volume of data to increase the overall transfer time.

At step 208, the ratio of time it takes to transfer the volume of data with compression, to the time it takes to transfer the volume of data without compression, is constantly determined by the following equation, at least according to one embodiment of the present disclosure:

$$k = \frac{{τ}_{compressed}}{{τ}_{uncompressed}} = \frac{( \frac{{m}_{compressed}}{{V}_{net}} + {τ}_{read} + {τ}_{compression} + {τ}_{decompression} )}{\frac{{m}_{original}}{{V}_{net}} + {τ}_{read}} = \frac{( \frac{{k}_{bin} {m}_{bin} + {k}_{txt} {m}_{txt}}{{V}_{net}} + {k}_{5} {V}_{hdd} + {m}_{original} ( {k}_{3} + {k}_{4} / ( 1 - {V}_{cpu} ) ) )}{\frac{{m}_{original}}{{V}_{net}} + {k}_{5} {V}_{hdd}}$$

In at least one embodiment of the present disclosure, if k is <1 (i.e. the time to transfer with compression (τ_{compressed}), is less than the time to transfer without compression (τ_{uncompressed})), then data compression provides benefits and speeds up the transfer of the volume of data from the source system 102, to the destination system 108. It will be appreciated that compression is appropriate when the time required for transferring the volume of data with compression, is less than the time required for transferring the volume of data without compression. It will be further appreciated that this determination is made constantly, or at periodic times such that any calculated value of k accurately reflects the determination of whether compression is appropriate before transfer.

In step 210, the source system 102 is operated to transfer the volume of data to destination system 108. The source system 102 may use compression to compress the volume of data, prior to transfer, based on the calculated value of k, in step 208. As disclosed, if data compression provides benefits and speeds up the transfer of the volume of data from the source system 102, to the destination system 108, compression is used; otherwise, the source system 102 transfers the volume of data to the destination system 108, without the use of compression.

In at least one embodiment of the present disclosure, the analyzer 104 operates to transfer the volume of data by first splitting the volume of data into smaller groups, or so called ‘chunks.’ For example, a 1 gigabyte file can be split into five chunks of 200 megabyte files. It will be appreciated that a large volume of data can be split into a plurality of chunks such that the chunks are no larger than a certain size (e.g. 1 megabyte), or that the number of chunks cannot exceed a certain value (e.g. no more than five chunks). In yet another embodiment of the present disclosure, a large volume of data can be split into any arbitrary number of chunks, or chunks having any arbitrary size, as would be well known to one having ordinary skill in the art. If the volume of data is split into chunks, each chunk may be transferred individually, and each chunk is analyzed for the benefits of compression, as disclosed above, and transferred with, or without compression, to the destination system 108.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

What is claimed is:

1. A system for optimizing data transfers across a network to a destination system, the system comprising:
a source system; and
an analyzer configured to collect a plurality of metrics from the source system and the network;
the analyzer further configured to calculate a cost ratio for a transfer of a volume of data, via the network to the destination system, the cost ratio comprising a time to transfer the volume of data with compression, divided by a time to transfer the volume of data without compression.

2. The system of claim 1, wherein the plurality of metrics are further collected from the destination system.

3. The system of claim 1, wherein the plurality of metrics are selected from a group consisting of CPU load, memory usage, hard disk read speed, and network transfer speed.

4. A method for optimizing data transfers over a network between a source system and a destination system, the method comprising the steps:
a. with an analyzer, collecting a plurality of metrics from the source system and the network;
b. receiving at the source system, a volume of data for transfer to the destination system, the volume of data comprising text files and binary files;
c. with the analyzer, calculating a first transfer cost to transfer the volume of data via the network to the destination system with first compressing the volume of data;
d. with the analyzer, calculating a second transfer cost to transfer the volume of data via the network to the destination system without compressing the volume of data;
e. constantly determining at the source system, a cost ratio, the cost ratio calculated by dividing the first transfer cost by the second transfer cost; and
f. compressing at the source system, the volume of data, if the cost ratio is less than 1.

5. The method of claim 4, further comprising the step of routing a compressed volume of data from the source system to the destination system via the network.

6. The method of claim 4, wherein step (a) further comprises collecting, at the source system, a plurality of metrics from the destination system.

7. The method of claim 6, wherein the first transfer cost further comprises the cost of decompressing a compressed volume of data at the destination system.

8. The method of claim 4, wherein the volume of data is split into a plurality of chunks.

9. The method of claim 8, wherein the each plurality of chunks is analyzed to determine, at the source system, a chunk cost ratio, wherein the chunk cost ratio is calculated by dividing the first transfer cost by the second transfer cost for the each plurality of chunks.
